(19) United States
(12) Patent Application Publication
(10) Pub. No.: US 2025/0140466 A1
(43) Pub. Date: May 1, 2025

(54) COIL COMPONENT

(71) Applicant: SAMSUNG ELECTRO-MECHANICS CO., LTD., Suwon-si (KR)

(72) Inventors: Han LEE, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/909,091

(22) Filed: Oct. 8, 2024

(30) Foreign Application Priority Data
Oct. 30, 2023 (KR) 10-2023-0146313

(51) Int. Cl. H01F 27/28; H01F 27/24; H01F 27/32

(52) U.S. Cl. CPC H01F 27/2804; H01F 27/24; H01F 2027/2809; H01F 27/323

(57) ABSTRACT

A coil component includes: a body having a first surface, a second surface opposing the first surface, and one or more side surfaces connecting the first and second surfaces to each other. First and second coils disposed inside the body each respectively include an upper coil layer and a lower coil layer, the first coil includes a first core, and the second coil includes a second core. The upper coil layer of the second coil is disposed between the upper and lower coil layer of the first coil. The lower coil layer of the first coil is disposed between the upper and lower coil layer of the second coil. The first core includes a first shared core overlapping the second core, and a first non-shared core that does not, and the second core includes a second shared core overlapping the first core, and a second non-shared core that does not.

### CROSS-REFERENCE TO RELATED APPLICATION(S)

This application claims benefit of priority to Korean Patent Application No. 10-2023-0146313 filed on Oct. 30, 2023 in the Korean Intellectual Property Office, the disclosure of which is incorporated herein by reference in its entirety.

### TECHNICAL FIELD

The present disclosure relates to a coil component.

In accordance with miniaturization and thinning of electronic devices such as a digital television (TV), a mobile phone, and a laptop computer, miniaturization and thinning of coil components used in such electronic devices have been demanded. In order to satisfy such a demand, research and development of various winding type or thin film type coil components have been actively conducted.

Meanwhile, in a coupled inductor, which has the advantage of reducing a mounting area of a coil component, two or more coils may be arranged in a vertical direction or a horizontal direction based on a mounting surface of the component. In a coupled inductor in which two or more coils are arranged in the vertical direction, when the coils are arranged to be separated into an upper coil and a lower coil, a characteristic deviation between the coils may be increased, which may have a negative effect on component characteristics.

### SUMMARY

An aspect of the present disclosure may enable efficient control of a characteristic deviation between coils by an arrangement structure of the coils.

According to an aspect of the present disclosure, a coil component includes: a body having a first surface, a second surface opposing the first surface in a first direction, and one or more side surfaces connecting the first and second surfaces to each other; and first and second coils disposed inside the body and respectively including an upper coil layer and a lower coil layer, the first coil including a first core, and the second coil including a second core, in which the upper coil layer of the second coil is disposed between the upper coil layer and the lower coil layer of the first coil, the lower coil layer of the first coil is disposed between the upper coil layer and the lower coil layer of the second coil, the first core includes a first shared core overlapping the second core, and a first non-shared core that does not overlap the second core, and the second core includes a second shared core overlapping the first core, and a second non-shared core that does not overlap the first core.

According to another aspect of the present disclosure, a coil component includes: a body having a first surface, a second surface opposing the first surface in a first direction, and one or more side surfaces connecting the first and second surfaces to each other; a support member disposed inside the body; and upper coil layers and lower coil layers disposed on both sides of the support member, respectively, in which the upper coil layers include a first upper coil layer and a second upper coil layer, the lower coil layers include a first lower coil layer connected to the first upper coil layer, and a second lower coil layer connected to the second upper coil layer, the first upper coil layer forms a first core, the second upper coil layer forms a second core, the first core includes a first shared core overlapping the second core, and a first non-shared core that does not overlap the second core, and the second core includes a second shared core overlapping the first core, and a second non-shared core that does not overlap the first core.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view illustrating a coil component according to a first exemplary embodiment in the present disclosure;

FIG. 2 is an exploded perspective view illustrating a coil connection structure of the coil component of FIG. 1;

FIG. 3 is a plan view of the coil component of FIG. 1 when viewed from above;

FIG. 4 is a plan view of coils of FIG. 1 when viewed from above;

FIG. 5 is a cross-sectional view taken along line I-I′ of FIG. 1;

FIG. 6 is a cross-sectional view taken along line II-II′ of FIG. 1;

FIG. 7 is a schematic perspective view illustrating a coil component according to a second exemplary embodiment in the present disclosure;

FIG. 8 is an exploded perspective view illustrating a coil connection structure of the coil component of FIG. 7;

FIG. 9 is a plan view of the coil component of FIG. 7 when viewed from above;

FIG. 10 is a plan view of the coils of FIG. 7 when viewed from above;

FIG. 11 is a cross-sectional view taken along line III-III′ of FIG. 7;

FIG. 12 is a cross-sectional view taken along line IV-IV′ of FIG. 7;

FIG. 13 is a schematic perspective view illustrating a coil component according to a comparative example; and

FIG. 14 is a plan view of the coil component of FIG. 13 when viewed from above.

### DETAILED DESCRIPTION

Terms used in the present specification are used only in order to describe specific exemplary embodiments rather than limiting the present disclosure. Singular forms are intended to include plural forms unless the context clearly indicates otherwise.

It is to be understood that the terms “include” or “have” used here specify the presence of features, numbers, steps, operations, components, parts, or combinations thereof mentioned in the present specification, or combinations thereof, but do not preclude the presence or addition of one or more other features, numbers, steps, operations, components, parts, or combinations thereof.

In addition, throughout the specification, “on” does not necessarily mean that any element is positioned on an upper side based on a gravity direction, but means that any element is positioned above or below a target portion.

Further, a term “couple” not only refers to a case where respective components are in physically direct contact with each other, but also refers to a case where the respective components are in contact with another component with another component interposed therebetween, in a contact relationship between the respective components.

As used herein, the expression “substantially parallel” may refer to two or more surfaces lying on imaginary planes that do not intersect, as will be appreciated by those of skill in the art, and allows for approximations, inaccuracies, and limits of measurement under the relevant circumstances. In one or more aspects, the terms “substantially,” “about,” and “approximately” may provide an industry-accepted tolerance for their corresponding terms and/or relativity between items, such as a tolerance of +1%, +5%, or +10% of the actual value stated, and other suitable tolerances. Since sizes and thicknesses of the respective components illustrated in the drawings are arbitrarily illustrated for convenience of explanation, the present disclosure is not necessarily limited to those illustrated in the drawings. In the drawings, an X-direction refers to a first direction or a T direction, a Y-direction refers to a second direction or a W direction, and a Z-direction refers to a third direction or an L direction.

Hereinafter, exemplary embodiments in the present disclosure will be described in detail with reference to the accompanying drawings. The exemplary embodiments in the present disclosure may be modified in many different forms and the scope of the present disclosure should not be limited to the exemplary embodiments set forth herein. Rather, the exemplary embodiments are provided to fully convey the concept of the present disclosure to those having ordinary skill in the art. In the drawings, the shapes and dimensions may be exaggerated for clarity, and the same reference numerals will be used throughout to designate the same or like components.

Various kinds of electronic components may be used in electronic devices, and various kinds of coil components may be appropriately used between these electronic components depending on their purposes in order to remove noise, or the like. That is, the coil components used in the electronic devices may be a power inductor, high frequency (HF) inductors, a general bead, a bead for a high frequency (GHz), a common mode filter, and the like.

### First Exemplary Embodiment

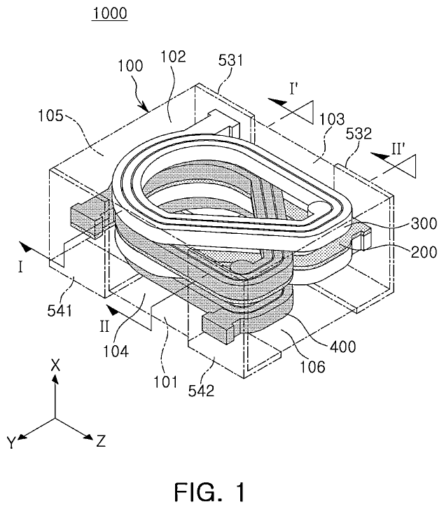

A coil component 1000 according to a first exemplary embodiment in the present disclosure will be described with reference to FIGS. 1 through 6.

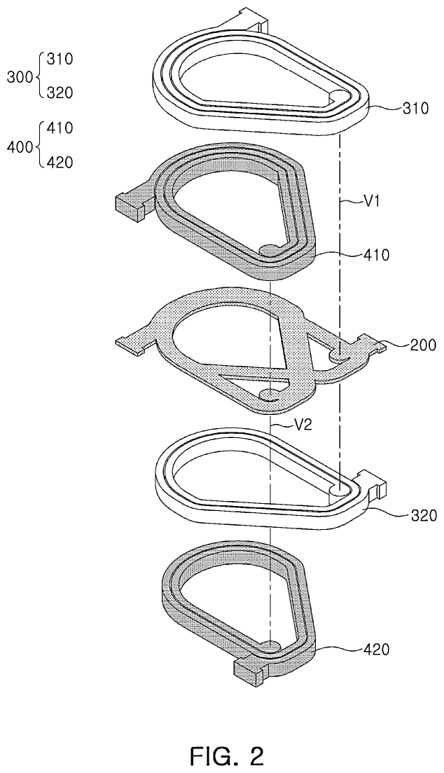

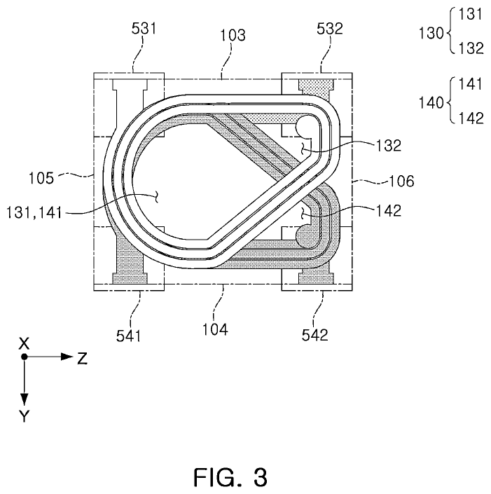

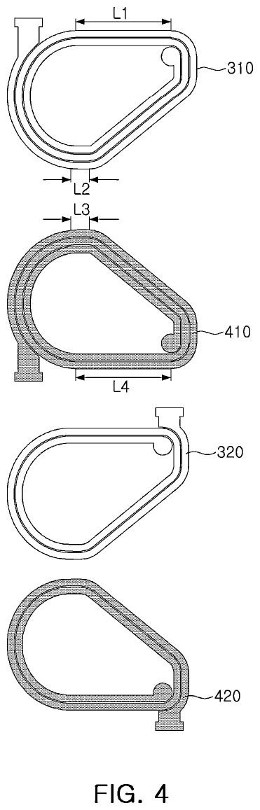

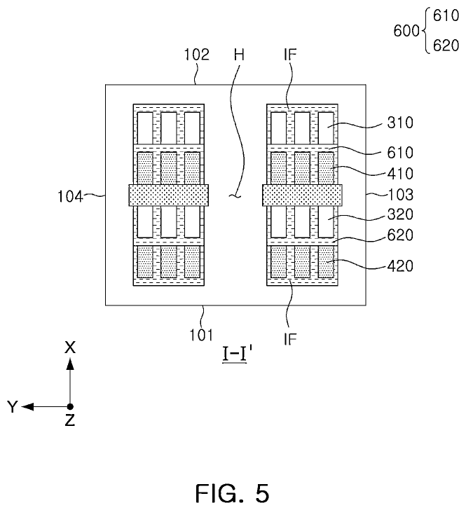

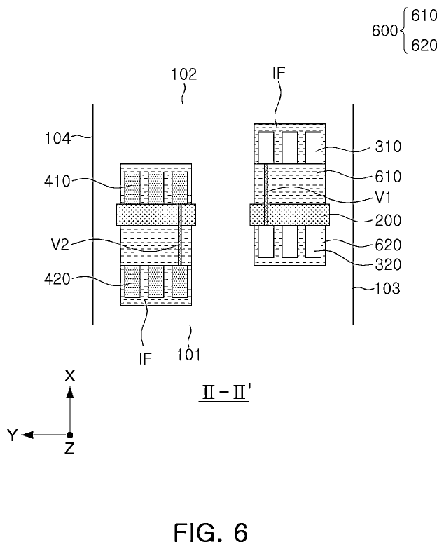

FIG. 1 is a schematic perspective view illustrating the coil component according to the first exemplary embodiment in the present disclosure. FIG. 2 is an exploded perspective view illustrating a coil connection structure of the coil component of FIG. 1. FIG. 3 is a plan view of the coil component of FIG. 1 when viewed from above. FIG. 4 is a plan view of coils of FIG. 1 when viewed from above. FIG. 5 is a cross-sectional view taken along line I-I′ of FIG. 1. FIG. 6 is a cross-sectional view taken along line II-II′ of FIG. 1.

Referring to FIGS. 1 through 6, the coil component 1000 according to the first exemplary embodiment in the present disclosure may include a body 100, a support member 200, a first coil 300, and a second coil 400, and may further include first to fourth external electrodes 531, 532, 541, and 542, an insulating layer 600, and an insulating film IF.

The body 100 may form an appearance of the coil component 1000 according to the first exemplary embodiment in the present disclosure, and may embed the support member 200 and the coils 300 and 400 therein.

The body 100 may have a first surface 101 and a second surface 102 opposing each other in the first direction (X-direction) and a plurality of side surfaces (third to sixth surfaces 103 to 106) connecting the first and second surfaces to each other. Specifically, the third surface 103 and the fourth surface 104 opposing each other in the second direction (Y-direction) connect the first surface 101 and the second surface 102, and the fifth surface 105 and the sixth surface 106 opposing each other in the third direction (Z-direction) connect the first surface 101 and the second surface 102. Here, the first direction (X-direction), the second direction (Y-direction), and the third direction (Z-direction) may be perpendicular to one another. The first direction (X-direction) may correspond to a thickness direction of the body 100. In the following description, the first direction (X-direction), the second direction (Y-direction), and the third direction (Z-direction) each represent both directions. For example, the first direction (X-direction) includes both upward and downward directions in the drawings. Hereinafter, for convenience of explanation, the expressions “upper” and “lower” are used. This is to easily explain a relative arrangement between components, and “upper” and “lower” do not necessarily refer to upper and lower sides in a direction of gravity.

The body 100 may include a resin and a magnetic material. Specifically, the body 100 may be formed by stacking one or more magnetic composite sheets in which the magnetic material is dispersed in the resin. The magnetic material may be ferrite or magnetic metal powder. The ferrite may be, for example, at least one of spinel type ferrite such as Mg—Zn-based ferrite, Mn—Zn-based ferrite, Mn—Mg-based ferrite, Cu—Zn-based ferrite, Mg—Mn—Sr-based ferrite, or Ni—Zn-based ferrite, hexagonal ferrite such as Ba—Zn-based ferrite, Ba—Mg-based ferrite, Ba—Ni-based ferrite, Ba—Co-based ferrite, or Ba—Ni—Co-based ferrite, garnet type ferrite such as Y-based ferrite, or Li-based ferrite. The magnetic metal powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may be at least one of pure iron powder, Fe—Si-based alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder, or Fe—Cr—Al-based alloy powder. The magnetic metal powder may be amorphous or crystalline. For example, the magnetic metal powder may be Fe—Si—B—Cr based amorphous alloy powder, but is not necessarily limited thereto. The ferrite and the magnetic metal powder may each have an average diameter of about 0.1 μm to 30 μm, but are not limited thereto. The body 100 may include two or more kinds of magnetic materials dispersed in the resin. Here, different kinds of magnetic materials mean that the magnetic materials dispersed in the resin are distinguished from each other by any one of an average diameter, a composition, crystallinity, and a shape. The resin may include epoxy, polyimide, liquid crystal polymer (LCP), or the like, or mixtures thereof, but is not limited thereto.

As an example of a manufacturing method, the body 100 may be formed by a stacking method. Specifically, a plurality of unit stacks for manufacturing the body 100 may be prepared and stacked on and under the coils 300 and 400. The unit stack may be manufactured in a sheet shape by mixing magnetic metal particles, a thermosetting resin, and organic materials such as a binder and a solvent with one another to prepare a slurry, applying the slurry at a thickness of several ten micrometers on a carrier film by, for example, a doctor blade method, and then drying the slurry. Therefore, the unit stack may be manufactured in a form in which the magnetic particles are dispersed in the thermosetting resin such as an epoxy resin or a polyimide resin.

Meanwhile, the body 100 may include cores 130 and 140 penetrating through the support member 200 and the coils 300 and 400 described below. The cores may be formed by filling through-holes penetrating through centers of the support member 200 and the coils 300 and 400 with magnetic composite sheets containing a magnetic material. Accordingly, the first core 130 may be formed in the first coil 300 and the second core 140 may be formed in the second coil 400, which will be described in detail below in the description of the coils.

The support member 200 may be disposed inside the body 100 and support the coils 300 and 400. However, according to some exemplary embodiments, the support member 200 may not be provided. For example, in a case where a winding type coil is used, the support member 200 may not be provided. The coil component 1000 according to the first exemplary embodiment may relate to a thin film type inductor in which electroplating is performed on the support member 200.

During trimming for forming the cores 130 and 140, a central portion of the support member 200 may be removed to form a through-hole H.

The support member 200 may have one surface opposing the second surface 102 of the body 100 (an upper surface in FIG. 2) and the other surface opposing the first surface 101 of the body 100 (a lower surface in FIG. 2).

Meanwhile, the support member 200 may be formed of an insulating material including a thermosetting insulating resin such as an epoxy resin, a thermoplastic insulating resin such as a polyimide resin, or a photosensitive insulating resin or be formed of an insulating material having a reinforcing material such as a glass fiber or an inorganic filler impregnated in such an insulating resin. As an example, the support member 200 may be formed of an insulating material such as prepreg, an Ajinomoto Build-up Film (ABF), FR-4, a Bismaleimide Triazine (BT) resin, or a photoimagable dielectric (PID), but is not limited thereto. As a material of the inorganic filler, one or more materials selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used. In a case where the support member 200 is formed of the insulating material including the reinforcing material, the support member 200 may provide more excellent rigidity. In a case where the support member 200 is formed of an insulating material that does not include a glass fiber, the support member 200 may be advantageous in decreasing a thickness of the coil component 1000 according to the present exemplary embodiment. A volume occupied by the coils 300 and 400 and/or the magnetic metal powder may be increased on the basis of the body 100 having generally the same size, such that component characteristics may be improved. In a case where the support member 200 is formed of the insulating material including the photosensitive insulating resin, the number of processes for forming the coils 300 and 400 may be decreased, which may be advantageous in reducing a production cost and forming fine vias. A thickness of the support member 200 may be, for example, 10 μm or more and 50 μm or less, but is not limited thereto.

The coil connection structure will be described with reference to FIG. 2.

The coil component 1000 according to the present exemplary embodiment may include the first coil 300 and the second coil 400. That is, the coil component according to the present exemplary embodiment may be an array type coil component, and may specifically be a coupled inductor. However, the coil component according to the present exemplary embodiment is not necessarily limited thereto.

As described below, the first coil 300 and the second coil 400 may be spaced apart from each other in the first direction (X-direction). Specifically, the first coil 300 and the second coil 400 may each have upper and lower coil layers alternately arranged in the first direction (X-direction). The first coil 300 may not be physically connected to the second coil 400. That is, the coil component 1000 according to the present exemplary embodiment may be a coil array in which coils are arranged in the vertical direction. The first coil 300 will be described with reference to FIGS. 2, 4, 5, and 6.

The first coil 300 may include an upper coil layer 310 and a lower coil layer 320 spaced from one another in the first direction (X-direction). In FIG. 2, the upper coil layer 310 is disposed on an upper side, and the lower coil layer 320 is disposed on a lower side. For convenience, the upper coil layer 310 of the first coil 300 may be referred to as the first upper coil layer 310. For convenience, the lower coil layer 320 of the first coil 300 may be referred to as the first lower coil layer 320. As described above, the expressions “upper” and “lower” are used for convenience of explanation. This is to easily explain a relative arrangement between components, and “upper” and “lower” do not necessarily refer to the upper and lower sides in the direction of gravity.

The first upper coil layer 310 may be disposed on one surface (the upper surface in FIG. 2) of the support member 200, and the first lower coil layer 320 may be disposed on the other surface of the support member 200 (the lower surface in FIG. 2).

The upper and lower coil layers 310 and 320 of the first coil 300 may form at least one turn.

Referring to FIGS. 1 and 6, one end of the first upper coil layer 310 may extend to the third surface 103 of the body 100, and the other end of the first upper coil layer 310 may be connected to the first lower coil layer 320.

One end of the first lower coil layer 320 may extend to the third surface 103 of the body 100, and the other end of the first lower coil layer 320 may be connected to the first upper coil layer 310.

A second upper coil layer 410 (described below) may be disposed between the first upper coil layer 310 and the first lower coil layer 320, but the first upper coil layer 310 and the first lower coil layer 320 may not be connected (e.g., electrically connected) to the second upper coil layer 410.

A first via V1 may connect the an end of the first upper coil layer 310 and the corresponding end of the first lower coil layer 320. The first and second external electrodes 531 and 532 described below may be disposed on the third surface 103 of the body 100 and may be connected to one end of the first upper coil layer 310 and one end of the first lower coil layer 320, respectively. As a result, the first coil 300 may function as a single coil.

Referring to FIG. 4, the first upper coil layer 310 may have a first straight portion L₁ and a second straight portion L₂, the first straight portion L₁ being adjacent to the third surface 103 of the body 100 and being substantially parallel to the third surface 103 of the body 100, and the second straight portion L₂ being adjacent to the fourth surface 104 of the body 100 and being substantially parallel to the fourth surface 104 of the body 100. Here, the straight portion may refer to the outermost coil portion whose curvature is substantially 0. That is, since the straight portion is substantially parallel to the third and fourth surfaces 103 and 104, the curvature thereof may be substantially 0.

The length of the first straight portion L₁ may be larger than a length of the second straight portion L₂. The length of the first straight portion L₁ of the first upper coil layer 310 may be larger than the length of the second straight portion L₂ such that the core 130 may have a trapezoid shape when viewed from the first direction (X-direction), but the shape of the core 130 is not necessarily limited thereto.

The first straight portion L₁ may be disposed closer to the sixth surface 106 of the body 100 than the second straight portion L₂. Accordingly, a first shared core 131 may be disposed closer to the fifth surface 105 of the body 100 than a first non-shared core 132 as described below.

The second coil 400 will be described with reference to FIGS. 2, 4, 5, and 6.

The second coil 400 may include the upper coil layer 410 and a lower coil layer 420 along the first direction (X-direction). In FIG. 2, the upper coil layer 410 is disposed on an upper side, and the lower coil layer 420 is disposed on a lower side. For convenience, the upper coil layer 410 of the second coil 400 may be referred to as the second upper coil layer 410. For convenience, the lower coil layer 420 of the second coil 400 may be referred to as the second lower coil layer 420.

The second upper coil layer 410 may be disposed on one surface (the upper surface in FIG. 2) of the support member 200, and the second lower coil layer 420 may be disposed on the other surface of the support member 200 (the lower surface in FIG. 2).

Hereinafter, arrangement of the coil layers, which is one of characteristic configurations of the present disclosure, will be described in detail. The second coil 400 may be disposed inside the body 100 without being in contact with the first coil 300. The coil layers of the first coil 300 and the second coil 400 may be alternately arranged. In some embodiments, the upper coil layer 410 of the second coil 400 may be disposed between the upper coil layer 310 of the first coil 300 and the lower coil layer 320 of the first coil 300, and the lower coil layer 320 of the first coil 300 may be disposed between the upper coil layer 410 of the second coil 400 and the lower coil layer 420 of the second coil 400. Referring to FIGS. 2 and 5, it may be seen that the first upper coil layer 310, the second upper coil layer 410, the first lower coil layer 320, and the second lower coil layer 420 are arranged in this order.

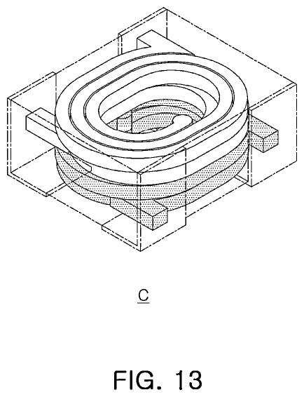

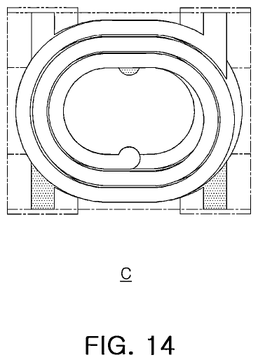

FIGS. 13 through 14 are views illustrating a coil component according to a comparative example. FIG. 13 is a schematic perspective view illustrating the coil component according to the comparative example. FIG. 14 is a plan view of the coil component of FIG. 13 when viewed from above.

In the coil component according to the comparative example, a first coil and a second coil were formed on one surface and the other surface of a support member, respectively. Accordingly, a coil that is positioned on a lower side is disposed close to a component mounting surface. A coil close to a mounting surface of the coil component has a problem that a magnetic flux and a capacity are decreased due to an influence of a land pattern of the mounting surface or a metal layer of a substrate. In addition, in a case of a coil that is positioned on an upper side, a path through which a signal flows is longer than that of the lower coil, and thus, a resistance thereof is higher than that of the coil positioned on the lower side.

That is, in a case where the coils are arranged to be separated into an upper coil and a lower coil as in the comparative example, a characteristic deviation between the coils may easily occur in a coupled inductor.

In the coil component 1000 according to the present disclosure, the first and second coils 300 and 400 are alternately arranged in the first direction (X-direction) to solve the above problem. As the coil layers of the first and second coils 300 and 400 are alternately arranged, deviations in capacity and resistance characteristic may be reduced. The following Table 1 is a table comparing characteristics (Rdc and Ls) of the coil component according to the comparative example and the coil component according to the first exemplary embodiment.

TABLE 1

| | | | First Exemplary | |
|---|---|---|---|---|
| | Comparative Example | | Embodiment | |
| | First Coil | Second Coil | First Coil | Second Coil |
| Rdc[mΩ] | 34.20 | 32.99 | 30.81 | 30.27 |
| Ls [nH] | 0.365 | 0.354 | 0.350 | 0.348 |

| | | |
|---|---|---|
| Rdc Difference (%) | 3.68 | 1.78 |
| Ls Difference (%) | 3.00 | 0.67 |

Referring to Table 1, it may be seen that, in the comparative example, differences (ratio) in Rdc and Ls between the first coil and the second coil were 3.68% and 3.00%, respectively, and in the first exemplary embodiment, differences (ratio) in Rdc and Ls between the first coil and the second coil were 1.78% and 0.67%, respectively. That is, it may be confirmed that the coil component according to the exemplary embodiment in the present disclosure has a reduced characteristic deviation between the first and second coils 300 and 400 as compared to the comparative example.

The upper and lower coil layers 410 and 420 of the second coil 400 may form at least one turn.

Referring to FIG. 6, one end of the second upper coil layer 410 may extend to the fourth surface 104 of the body 100, and the other end of the second upper coil layer 410 may be connected to the second lower coil layer 420.

One end of the second lower coil layer 420 may extend to the fourth surface 104 of the body 100, and the other end of the second lower coil layer 420 may be connected to the second upper coil layer 410.

The first lower coil layer 320 may be disposed between the second upper coil layer 410 and the second lower coil layer 420, but the second upper coil layer 410 and the second lower coil layer 420 may not be connected to the first lower coil layer 320.

A second via V2 may connect the other end of the second upper coil layer 410 and the other end of the second lower coil layer 420. The third and fourth external electrodes 541 and 542 described below may be disposed on the fourth surface 104 of the body 100 and may be connected to one end of the second upper coil layer 410 and one end of the second lower coil layer 420, respectively. As a result, the second coil 400 may function as a single coil.

Referring to FIG. 4, the second upper coil layer 410 may have a third straight portion L₃ and a fourth straight portion L₄, the third straight portion L₃ being adjacent to the third surface 103 of the body 100 and being substantially parallel to the third surface 103 of the body 100, and the fourth straight portion L₄ being adjacent to the fourth surface 104 of the body 100 and being substantially parallel to the fourth surface 104 of the body 100. Here, the straight portion may refer to the outermost coil portion whose curvature is substantially 0. That is, since the straight portion is substantially parallel to the third and fourth surfaces 103 and 104, the curvature thereof may be substantially 0.

The length of the fourth straight portion L4 may be larger than a length of the third straight portion L3. The length of the fourth straight portion L₄ of the second upper coil layer 410 being larger than the length of the third straight portion L₃ may result in the core 140 having a trapezoid shape when viewed from the first direction (X-direction), but the shape of the core 140 is not necessarily limited thereto.

The fourth straight portion L₄ may be disposed closer to the sixth surface 106 of the body 100 than the third straight portion L₃. Accordingly, a second shared core 141 may be disposed closer to the fifth surface 105 of the body 100 than a second non-shared core 142 as described below.

The coils 300 and 400 and the vias V may be formed by a plating method used in the related art, such as a pattern plating method, an anisotropic plating method, or an isotropic plating method, and may also be formed to have a multilayer structure by using a plurality of methods among the methods. Meanwhile, examples of a material of the coils 300 and 400 and the vias V include conductive materials such as copper (Cu), aluminum (Al), silver (Ag), tin (Sn), gold (Au), nickel (Ni), and alloys thereof, but are not limited thereto.

In a case where the coil layers 310, 320, 410, and 420 are formed by plating, each coil layer may include a seed layer and an electroplating layer. The seed layer may be formed by a vapor deposition method such as an electroless plating method or a sputtering method. Each of the seed layer and the electroplating layer may have a single-layer structure or have a multilayer structure. The electroplating layer having the multilayer structure may be formed in a conformal film structure in which another electroplating layer covers any one electroplating layer, or may be formed to have a shape in which another electroplating layer is stacked on only one surface of any one electroplating layer. The seed layer of the coil layer and a seed layer of the via V may be integrally formed, and a boundary therebetween may not be formed, but the seed layers are not limited thereto. The electroplating layer of the coil layer and an electroplating layer of the via V may be integrally formed, and a boundary therebetween may not be formed, but the electroplating layers are not limited thereto.

Hereinafter, the shapes and arrangement of the cores 130 and 140 according to the present disclosure will be described with reference to FIG. 3. For convenience of explanation, the support member 200 is omitted in FIG. 3.

The coil component 1000 according to the first exemplary embodiment in the present disclosure may include the first core 130 and the second core 140.

The first coil 300 may form at least one turn, and the first core 130 may be formed by filling a region penetrating through the center of the first coil 300 with a portion of the body 100. For convenience of explanation, the region penetrating through the center of the first upper coil layer 310 may be referred to as the first core 130.

Similarly, the second coil 400 may form at least one turn, and the second core 140 may be formed by filling a region penetrating through the center of the second coil 400 with a portion of the body 100. For convenience of explanation, the region penetrating through the center of the second upper coil layer 410 may be referred to as the second core 140.

Referring to FIG. 3, the first core 130 may include the first shared core 131 overlapping the second core 140, and the first non-shared core 132 that does not overlap the second core 140. Here, “overlapping” may mean that the regions overlap each other when viewed from an axial direction (the X-direction in FIG. 3) of the cores 130 and 140.

Similarly, the second core 140 may include the second shared core 141 overlapping the first core 130 and the second non-shared core 142 that does not overlap the first core 130.

In the coil component 1000 according to an exemplary embodiment in the present disclosure, the coils 300 and 400 may be formed adjacent to each other while sharing the cores 130 and 140. Therefore, the coupling coefficient may be adjusted by appropriately increasing or decreasing a relative area ratio of the shared cores and the non-shared cores. A leakage inductance and a mutual inductance may be adjusted to desired values. The closer the value of the coupling coefficient to 1, the larger the coupling coefficient, and a negative (−) sign indicates negative coupling.

The first shared core 131 may be disposed closer to the fifth surface 105 of the body 100 than the first non-shared core 132. The first non-shared core 132 may be disposed closer to the sixth surface 106 of the body 100 than the first shared core 131.

Similarly, the second shared core 141 may be disposed closer to the fifth surface 105 of the body 100 than the second non-shared core 142. The second non-shared core 142 may be disposed closer to the sixth surface 106 of the body 100 than the second shared core 141. That is, the first and second non-shared cores 132 and 142 may be disposed on the same side in the third direction (Z-direction) with respect to the first and second shared cores 131 and 141.

The first non-shared core 132 may be disposed closer to the third surface 103 of the body 100 than the second non-shared core 142. The second non-shared core 142 may be disposed closer to the fourth surface 104 of the body 100 than the first non-shared core 132.

Since the first and second non-shared cores 132 and 142 are disposed on the same side in the third direction (Z-direction) of the body 100 with respect to the first and second shared cores 131 and 141, coil misalignment due to process variations during coil formation may be minimized, thereby reducing the characteristic deviation of the coil component and increasing yield.

The coil component 1000 according to the first exemplary embodiment in the present disclosure may further include the external electrodes 531, 532, 541, and 542.

The first to fourth external electrodes 531, 541, 532, and 542 may be disposed outside the body 100 and connected to the coils 300 and 400. Specifically, the first and second external electrodes 531 and 532 may be disposed on the third surface 103 of the body 100, and the third and fourth external electrodes 541 and 542 may be disposed on the fourth surface 104 of the body 100.

The first and second external electrodes 531 and 532 may be disposed to be spaced apart from each other on the third surface 103 of the body 100 and may be connected to one end of the first upper coil layer 310 and one end of the first lower coil layer 320, respectively. The third and fourth external electrodes 541 and 542 may be disposed to be spaced apart from each other on the fourth surface 104 of the body 100 and may be connected to one end of the second upper coil layer 410 and one end of the second lower coil layer 420, respectively.

The first to fourth external electrodes 531, 532, 541, and 542 may be formed using a paste containing a metal having excellent electrical conductivity, such as a conductive paste containing nickel (Ni), copper (Cu), tin (Sn), or silver (Ag), or alloys thereof. In addition, a plating layer may be provided to cover each of the first to fourth external electrodes 531, 532, 541, and 542. In this case, the plating layers may include one or more selected from the group consisting of nickel (Ni), copper (Cu), and tin (Sn). For example, nickel (Ni) layers and tin (Sn) layers may be sequentially formed in the plating layers.

The coil component 1000 according to the first exemplary embodiment in the present disclosure may further include the insulating layer 600.

Referring to FIGS. 5 and 6, the coil component according to the first exemplary embodiment may include an upper insulating layer 610 disposed between the first upper coil layer 310 and the second upper coil layer 410, and a lower insulating layer 620 disposed between the first lower coil layer 320 and the second lower coil layer 420.

Referring to FIG. 5, the upper insulating layer 610 may be disposed between the first upper coil layer 310 and the second upper coil layer 410 and cover the second upper coil layer 410. The lower insulating layer 620 may be disposed between the first lower coil layer 320 and the second lower coil layer 420 and cover the first lower coil layer 320.

The insulating layers 610 and 620 may be formed of an insulating material including at least one of a thermosetting insulating resin such as an epoxy resin, a thermoplastic insulating resin such as a polyimide resin, or a photosensitive insulating resin or be formed of an insulating material including a reinforcing material such as a glass fiber or an inorganic filler impregnated in such an insulating resin. For example, the insulating layers 610 and 620 may be formed by stacking insulation films on both surfaces of the support member 200 on which the second upper coil layer 410 and the first lower coil layer 320 are disposed. Specifically, the insulating layers 610 and 620 may be formed by stacking a film type insulating material such as prepreg, an Ajinomoto Build-up Film (ABF), FR-4, a Bismaleimide Triazine (BT) film, or a photoimagable dielectric (PID) film, but is not limited thereto, and may be formed by applying and then curing a liquid insulating resin.

Referring to FIG. 6, the first via V1 may penetrate through the support member 200 and the upper insulating layer 610 to connect the first upper coil layer 310 and the first lower coil layer 320 to each other.

Similarly, the second via V2 may penetrate through the support member 200 and the lower insulating layer 620 to connect the second upper coil layer 410 and the second lower coil layer 420 to each other.

The insulating film IF may be formed on the surface of each of the first upper coil layer 310 and the second lower coil layer 420. The insulating film IF may be disposed between the first upper coil layer 310 and the second lower coil layer 420, and the body 100. The insulating film IF may fill a region such as a space between adjacent turns of the first upper coil layer 310 and the second lower coil layer 420. The insulating film IF may be used to electrically separate the first upper coil layer 310 and the second lower coil layer 420, and the body 100 from each other, and may include a known insulating material such as parylene, but is not limited thereto. As another example, the insulating film IF may include an insulating material such as an epoxy resin rather than parylene. The insulating film IF may be formed by a vapor deposition method, but is not limited thereto. As another example, the insulating film IF may be formed by stacking and then curing an insulation film for forming the insulating film IF on each of both surfaces of the first upper coil layer 310 and the second lower coil layer 420 in a state where the first upper coil layer 310 and the second lower coil layer 420 are formed, or may be formed by applying and then curing an insulation paste for forming the insulating film IF onto both surfaces of the first upper coil layer 310 and the second lower coil layer 420 in a state where the first upper coil layer 310 and the second lower coil layer 420 are formed. Meanwhile, for the reason described above, the insulating film IF may be omitted in the present exemplary embodiment. That is, when the body 100 has a sufficient electrical resistance at a designed operating current and voltage of the coil component 1000, the insulating film IF may be omitted in the present exemplary embodiment.

### Second Exemplary Embodiment

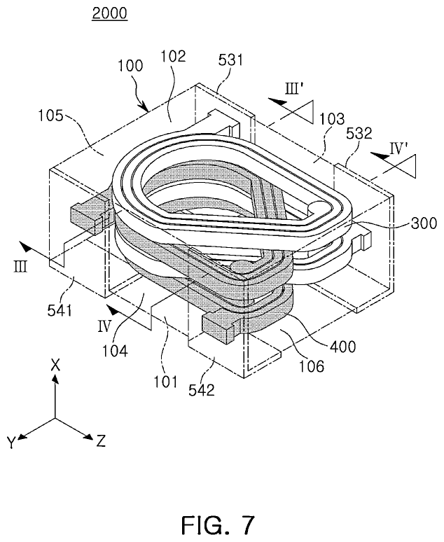

A coil component 2000 according to a second exemplary embodiment in the present disclosure will be described with reference to FIGS. 7 through 12.

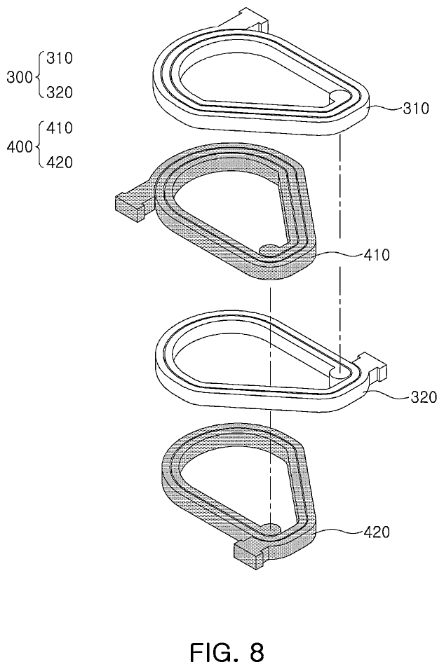

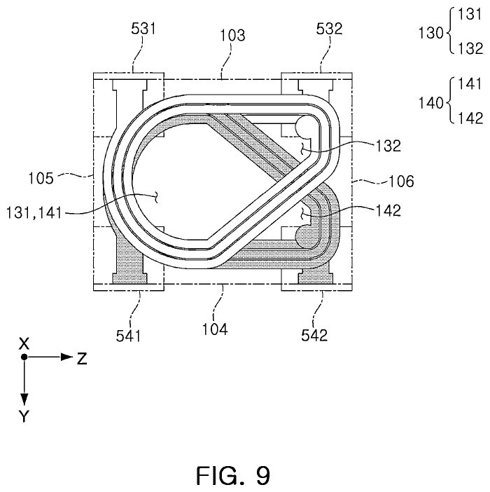

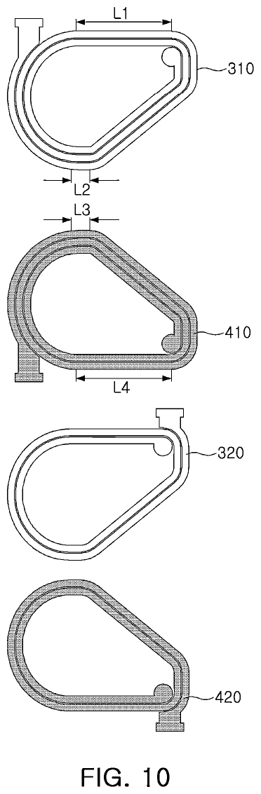

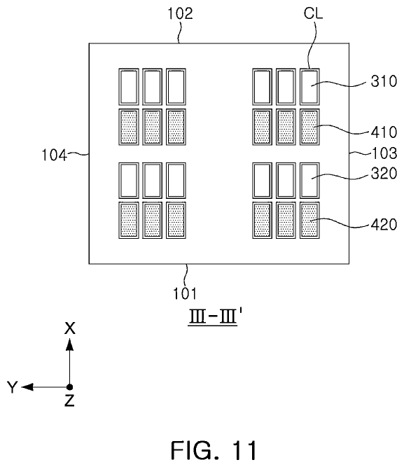

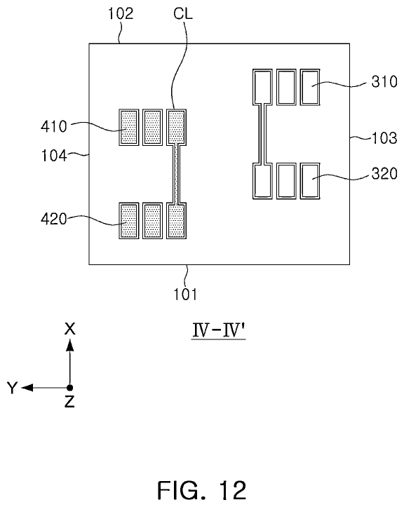

FIG. 7 is a schematic perspective view illustrating the coil component according to the second exemplary embodiment in the present disclosure. FIG. 8 is an exploded perspective view illustrating a coil connection structure of the coil component of FIG. 7. FIG. 9 is a plan view of the coil component of FIG. 7 when viewed from above. FIG. 10 is a plan view of the coils of FIG. 7 when viewed from above. FIG. 11 is a cross-sectional view taken along line III-III′ of FIG. 7. FIG. 12 is a cross-sectional view taken along line IV-IV′ of FIG. 7.

The coil component 2000 according to the second exemplary embodiment is different from the coil component 1000 according to the first exemplary embodiment in that the support member 200 and the insulating layers 610 and 620 are omitted. Referring to FIGS. 11 and 12, it may be confirmed that the support member 200 and the insulating layers 610 and 620 are omitted unlike the first exemplary embodiment.

First and second coils 300 and 400 of the coil component 2000 according to the second exemplary embodiment may each be a winding coil formed by winding a metallic wire such as a copper wire (Cu-wire) including a metal wire and a coating layer CL covering the surface of the metal wire in a spiral shape. The metallic wire may be a flat wire, but is not limited thereto. In a case where the coils 300 and 400 are formed using flat wires, a cross section of each turn of the coil may have a rectangular shape. The metallic wire may be formed of a conductive material such as copper (Cu), aluminum (Al), silver (Ag), tin (Sn), gold (Au), nickel (Ni), lead (Pb), titanium (Ti), chromium (Cr), molybdenum (Mo), or alloys thereof, but is not limited thereto. The coating layer CL may include epoxy, polyimide, liquid crystal polymer, or the like, or mixtures thereof, but is not limited thereto.

The description in the first exemplary embodiment may be applied to other components of the present exemplary embodiment as it is, and thus, a description of other components is omitted.

As set forth above, according to an exemplary embodiment in the present disclosure, the coil component may enable efficient control of a characteristic deviation between coils by an arrangement structure of the coils.

While example embodiments have been shown and described above, it will be apparent to those skilled in the art that modifications and variations could be made without departing from the scope of the present invention as defined by the appended claims.

What is claimed is:

1. A coil component comprising:
a body having a first surface, a second surface opposing the first surface in a first direction, and third to sixth surfaces that are side surfaces connecting the first and second surfaces to each other; and
first and second coils disposed inside the body and each respectively including an upper coil layer and a lower coil layer, the first coil including a first core, and the second coil including a second core,
wherein the upper coil layer of the second coil is disposed between the upper coil layer and the lower coil layer of the first coil,
the lower coil layer of the first coil is disposed between the upper coil layer and the lower coil layer of the second coil,
the first core includes a first shared core overlapping the second core, and a first non-shared core that does not overlap the second core, and
the second core includes a second shared core overlapping the first core, and a second non-shared core that does not overlap the first core.

2. The coil component according to claim 1, wherein the first and second shared cores are disposed closer to the fifth surface of the body than the first and second non-shared cores, and
the first and second non-shared cores are disposed closer to the sixth surface of the body than the first and second shared cores.

3. The coil component according to claim 1, wherein the first non-shared core is disposed closer to the third surface of the body than the second non-shared core, and
the second non-shared core is disposed closer to the fourth surface of the body than the first non-shared core.

4. The coil component according to claim 1, wherein the first coil and the second coil are spaced apart from each other.

5. The coil component according to claim 1, wherein each of the coil layers of the first and second coils forms at least one turn.

6. The coil component according to claim 1, wherein the upper coil layer of the first coil has a first straight portion and a second straight portion, the first straight portion being adjacent to the third surface of the body and being substantially parallel to the third surface of the body, and the second straight portion being adjacent to the fourth surface of the body and being substantially parallel to the fourth surface of the body,
the upper coil layer of the second coil has a third straight portion and a fourth straight portion, the third straight portion being adjacent to the third surface of the body and being substantially parallel to the third surface of the body, and the fourth straight portion being adjacent to the fourth surface of the body and being substantially parallel to the fourth surface of the body,
a length of the first straight portion is larger than a length of the second straight portion, and
a length of the fourth straight portion is larger than a length of the third straight portion.

7. The coil component according to claim 6, wherein the first straight portion is disposed closer to the sixth surface of the body than the second straight portion, and
the fourth straight portion is disposed closer to the sixth surface of the body than the third straight portion.

8. The coil component according to claim 1, wherein one end of the upper coil layer of the first coil extends to the third surface of the body,
one end of the lower coil layer of the first coil extends to the third surface of the body,
one end of the upper coil layer of the second coil extends to the fourth surface of the body, and
one end of the lower coil layer of the second coil extends to the fourth surface of the body.

9. The coil component according to claim 1, further comprising:
first and second external electrodes disposed on the third surface of the body; and
third and fourth external electrodes disposed on the fourth surface of the body.

10. A coil component comprising:
a body having a first surface, a second surface opposing the first surface in a first direction, and third to sixth surfaces that are side surfaces connecting the first and second surfaces to each other;
a support member disposed inside the body; and
upper coil layers and lower coil layers disposed on both sides of the support member, respectively,
wherein the upper coil layers include a first upper coil layer and a second upper coil layer,
the lower coil layers include a first lower coil layer connected to the first upper coil layer, and a second lower coil layer connected to the second upper coil layer,
the first upper coil layer forms a first core, and the second upper coil layer forms a second core,
the first core includes a first shared core overlapping the second core, and a first non-shared core that does not overlap the second core, and
the second core includes a second shared core overlapping the first core, and a second non-shared core that does not overlap the first core.

11. The coil component according to claim 10, wherein the first upper coil layer, the second upper coil layer, the first lower coil layer, and the second lower coil layer are arranged in an order of the first upper coil layer, the second upper coil layer, the first lower coil layer, and the second lower coil layer in the first direction.

12. The coil component according to claim 10, further comprising:
a first insulating layer disposed between the first upper coil layer and the second upper coil layer; and
a second insulating layer disposed between the first lower coil layer and the second lower coil layer.

13. The coil component according to claim 10, further comprising:
a first via connecting the first upper coil layer and the first lower coil layer; and
a second via connecting the second upper coil layer and the second lower coil layer.

14. The coil component according to claim 13, wherein the first and second vias penetrate through the support member.

15. The coil component according to claim 10, wherein the first and second shared cores are disposed closer to the fifth surface of the body than the first and second non-shared cores, and
the first and second non-shared cores are disposed closer to the sixth surface of the body than the first and second shared cores.

16. The coil component according to claim 10, wherein the first non-shared core is disposed closer to the third surface of the body than the second non-shared core, and
the second non-shared core is disposed closer to the fourth surface of the body than the first non-shared core.
